(19) United States
(12) Patent Application Publication
(10) Pub. No.: US 2023/0220530 A1
(43) Pub. Date: Jul. 13, 2023

(54) USE OF PRODUCTS MADE FROM ALUMINIUM COPPER MAGNESIUM ALLOY THAT PERFORM WELL AT HIGH TEMPERATURE

(71) Applicant: CONSTELLIUM ISSOIRE, Issoire (FR)

(72) Inventors: Pablo LORENZINO, Saint Cassien (FR); Lukasz DOLEGA, Saint Martin Le Vinoux (FR)

(21) Appl. No.: 18/000,322

(22) PCT Filed: May 31, 2021
(86) PCT No.: PCT/FR2021/050981

§ 371 Date: Nov. 30, 2022

(30) Foreign Application Priority Data
Jun. 4, 2020 (FR) 2005856

(51) Int. Cl. C22F 1/057; C22C 21/18; C22C 21/16; C22C 21/14

(52) U.S. Cl. CPC C22F 1/057; C22C 21/18; C22C 21/16; C22C 21/14

(57) ABSTRACT

The invention relates to the use of a wrought aluminum alloy in a T8 temper with the following composition, in wt %, Cu: 3.6-4.4; Mg: 1.2-1.4; Mn: 0.5-0.8; Zr:≤0.15; Ti: 0.01-0.15; Si≤0.20; Fe≤0.20; Zn≤0.25 other elements<0.05; the remainder being aluminum, in an application in which the product is kept at temperatures of between 80° C. and 250° C. for a significant period of at least 200 hours. The products intended for the use according to the invention are particularly useful in an application such as a rotor or another component of an air suction pump such as, in particular, a vacuum pump.

### TECHNICAL FIELD

The invention relates to products made of aluminum-copper-magnesium alloys, more particularly, such products, the processes for manufacturing and using them, intended to be implemented at high temperature.

### PRIOR ART

Some aluminum alloys are routinely used for applications for which they have a high temperature of use, typically between 80 and 250° C. and generally between 100 and 200° C., for example as a structural component or attachment means near engines in the automotive or aerospace industry or as rotors or other air suction pump components such as particularly vacuum pumps.

These alloys require good mechanical performances at high temperature. Good mechanical performances at high temperature mean particularly, on one hand, thermal stability, i.e., the mechanical properties measured at ambient temperature are stable after long-term exposure at the temperature of use, and, on the other, hot performance, i.e., the mechanical properties measured at high temperature (static mechanical properties, creep resistance) are high.

Among the alloys known for this type of application, mention can be made of AA2618 alloy which comprises (in wt %):

Cu:1.9-2.7 Mg:1.3-1.8 Fe:0.9-1.3, Ni:0.9-1.2 Si:0.10-0.25 Ti:0.04-0.10 which was used for manufacturing Concorde.

The patent FR 2279852 proposes an alloy with a reduced iron and nickel content with the following composition (in wt %):

Cu:1.8-3 Mg:1.2-2.7 Si<0.3 Fe:0.1-0.4 Ni+Co: 0.1-0.4 (Ni+Co)/Fe: 0.9-1.3

The alloy can also contain Zr, Mn, Cr, V or Mo at contents less than 0.4%, and optionally Cd, In, Sn or Be at less than 0.2% each, Zn at less than 8% or Ag at less than 1%. With this alloy, a substantial improvement of the stress concentration factor K1c representative of the resistance to crack propagation is obtained.

Patent application EP 0 756 017 A1 relates to a composition with a high creep resistance with the following composition (in wt %):

Cu: 2.0-3.0 Mg: 1.5-2.1 Mn: 0.3-0.7

Fe<0.3 Ni<0.3 Ag<1.0 Zr<0.15 Ti<0.15

with Si such that: 0.3<Si+0.4Ag<0.6

other elements<0.05 each and <0.15 in total.

The patent RU2210614C1 describes an alloy with the following composition (in wt %):

Cu: 3.0-4.2 Mg: 1.0-2.2 Mn: 0.1-0.8 Zr: 0.03-0.2 Ti: 0.012-0.1, V: 0.001-0.15

at least one element from Ni: 0.001-0.25 and Co: 0.001-0.25, the remainder being aluminum.

Patent application WO2012/140337 relates to wrought Al—Cu—Mg aluminum alloy products with the following composition, in wt %, Cu: 2.6-3.7; Mg: 1.5-2.6; Mn: 0.2-0.5; Zr: ≤0.16; Ti: 0.01-0.15; Cr≤0.25; Si≤0.2; Fe≤0.2; other elements<0.05; the remainder being aluminum; where Cu>−0.9 (Mg)+4.3 and Cu<−0.9 (Mg)+5.0; where Cu=Cu−0.74 (Mn−0.2)−2.28 Fe and Mg=Mg−1.73 (Si−0.05) for Si≥0.05 and Mg=Mg for Si<0.05 and the manufacturing process thereof. The alloys mentioned in this application are particularly useful for applications wherein the products are kept at temperatures of 100° C. to 200° C., typically at around 150° C. The products mentioned in this application are useful for attachment components intended to be used in an automobile engine, such as screws or bolts or rivets or for manufacturing nacelle components and/or attachment struts for airplanes, airplane wing leading edges and supersonic airplane fuselage.

Patent application CN104164635 describes a process for enhancing resistance at ambient temperature and the performances at high temperature of an Al—Cu—Mg alloy for an aluminum alloy drill rod. The process comprises the steps whereby the Al—Cu—Mg alloy is pre-drawn and put out of shape by 0 to 8% after the solution heat treatment, then is heated to 160° C. to 190° C., for four hours to 120 hours, then, the alloy is removed from a furnace, air cooling is performed on the alloy and the copper to magnesium content ratio in the Al—Cu—Mg alloy is less than or equal to five, the composition of the alloy being, in wt %, Cu: 4.0%˜4.3%, Mg: 1.5%˜1.6%, Mn: 0.4%˜0.6%, Ti: 0.1% 0.15%, the remainder being Al.

Patent application CN107354413 relates to a technique for preparing a heat-resistant aluminum alloy material with high resistance for petroleum exploration, and belongs to the technical field of aluminum alloy heat treatment. The constituents of the alloy are determined as Si<0.35, Fe<0.45, Cu 4.0-4.5, Mn 0.40-0.80, Mg 1.3-1.7, Zn<0.10, Ti 0.08-0.20, Zr 0.10-0.15 and other impurities 0.00-0.15.

The patent RU2278179 C1 relates to aluminum-copper-magnesium alloys that can be used as structural materials in the field of aerospace comprising (in mass %) copper 3.8-5.5; magnesium 0.3-1.6; manganese 0.2-0.8; titanium 0,5,10 (−6) −0.07; tellurium 0.5.10 (−5) −0.01, at least one element from the group containing silver 0.2 −1.0; nickel 0.5.10 (−6) −0.05; zinc 0.5.10 (−6) −0.1; zirconium 0.05 −0.3; chromium 0.05 −0.3; iron 0.5.10 (−6) −0.15; silicon 0.5.10 (−6) −0.1; hydrogen 0.1.10 (−5) −2.7.10 (−5); and balance: aluminum.

Patent application WO2020074818 relates to a thin plate made of an alloy based on mainly recrystallized aluminum and having a thickness between 0.25 and 12 mm comprising, in wt %, Cu 3.4-4.0; Mg 0.5-0.8; Mn 0.1-0.7; Fe≤0.15; Si≤0.15; Zr≤0.04; Ag≤0.65; Zn≤0.5; unavoidable impurities 0.05 each and 0.15 in total; the remainder being aluminum.

Patent application US2004013529 relates to a mechanical vacuum pump comprising a rotor made of light metal alloy obtained by powder metallurgy. Powder metallurgy increases the heat and creep resistance of the rotor.

AA2219 alloy with the following composition (in wt %) Cu: 5.8-6.8 Mn: 0.20-0.40 Ti: 0.02-0.10, Zr: 0.10-0.25 V: 0.05-0.15 Mg<0.02 is also known for applications at high temperature.

However, these alloys exhibit insufficient properties for certain applications and also pose recycling problems due in particular to the iron and/or silicon and/or cobalt and/or vanadium content.

Al—Cu—Mg alloys are moreover known, which are most often in the T3 temper, an economical temper which does not require ageing heat treatment.

U.S. Pat. No. 3,826,688 discloses an alloy with the following composition (in wt %), Cu: 2.9-3.7, Mg: 1.3-1.7 and Mn: 0.1-0.4.

U.S. Pat. No. 5,593,516 discloses an alloy with the following composition (in wt %), Cu: 2.5-5.5, Mg: 0.1-2.3 within the limit of the solubility thereof, i.e., such that Cu is at most equal to Cuₘₐₓ=−0.91 (Mg)+5.59.

Patent application EP 0 038 605 A1 discloses an alloy with the following composition (in wt %), Cu: 3.8-4.4, Mg: 1.2-1.8 and Mn: 0.3-0.9, maximum 0.12 Si, 0.15 Fe, 0.25 Zn, 0.15 Ti and 0.10 Cr.

U.S. Pat. No. 6,444,058 discloses a high-purity Al—Mg—Cu alloy composition for which the effective values of Cu and Mg are defined, particularly by Cu_{target}=Cu_{eff}+0.74 (Mn−0.2)+2.28 (Fe−0.005), and discloses a composition range in the chart Cu_{eff}: Mg_{eff} wherein the maximum value of Mg_{eff} is of the order of 1.4 wt %.

There is a need for aluminum alloy products having good mechanical performances at high temperature, typically at 150° C., and which are easy to manufacture and recycle.

### DISCLOSURE OF THE INVENTION

The invention relates to the use of a wrought aluminum alloy in a T8 temper with the following composition, in wt %,

Cu: 3.6-4.4

Mg: 1.2-1.4

Mn: 0.5-0.8

Zr: ≤0.15

Ti: 0.01-0.05

Si≤0.20

Fe≤0.20

Zn≤0.25

other elements<0.05

the remainder being aluminum,

in an application wherein said product is kept at temperatures of 80° C. to 250° C. for a significant period of at least 200 hours.

### FIGURES

FIG. 1 shows the evolution of the ultimate tensile strength with the long term exposure time at 150° C. in hours.

### DETAILED DESCRIPTION OF THE INVENTION

Unless specified otherwise, all of the indications concerning the chemical composition of the alloys are expressed as a percentage by weight based on the total weight of the alloy. The expression 1.4 Cu or 1.4 (Cu) means that the copper content expressed in wt % is multiplied by 1.4. The alloys are designated in accordance with the Aluminum Association rules, known to a person skilled in the art. The definitions of the tempers are indicated in European standard EN 515-2017. This standard specifies in particular that a T8 temper: is a solution heat treated, artificially aged and cold worked temper, this designation applying to products which are subjected to cold working to improve the mechanical strength thereof, or for which the effect of cold working combined with levelling or straightening are translated to the mechanical property limits. T8 temper denotes all tempers for which the first digit after T is 8. For example, the T851 and T852 tempers are T8 tempers.

The tensile static mechanical properties, in other words the ultimate tensile strength Rₘ, the conventional yield strength at 0.2% elongation R_{p0.2}, and the elongation at rupture A %, are determined by a tensile test as per the standard NF EN ISO 6892-1, whereby the sampling and the direction of the test are defined by the standard EN 485-1. The hot tensile tests are performed as per the standard NF EN 10002-5. The creep tests are performed as per the standard ASTM E139-06. Unless specified otherwise, the definitions of the standard EN 12258 apply.

The present inventors observed that, surprisingly, there is a composition range of Al—Cu—Mg alloys containing Mn which makes it possible when they are used in the T8 temper to obtain wrought products that perform particularly well at high temperature.

The magnesium content is such that Mg is between 1.2 and 1.4 wt % and preferably between 1.25 and 1.35 wt %. When the Mg content is not within the range according to the invention, the mechanical properties are not satisfactory. In particular, the ultimate tensile strength Rₘ can be insufficient at ambient temperature and/or after long term exposure at 150° C.

The copper content is such that Cu is between 3.6 and 4.4 wt %. Advantageously, Cu is at least 3.9 wt % and preferably at least 4.0 wt %. Advantageously, Cu is at most 4.3 wt % and preferably at most 4.25 wt %.

The products intended for use according to the invention contain 0.5 to 0.8 wt % of manganese which particularly helps control the grain structure. Advantageously, the Mn content is between 0.51 and 0.65 wt %. The present inventors observed that simultaneously adding manganese and zirconium can be advantageous in some cases, particularly for reducing the sensitivity to long term exposure at high temperature while attaining high mechanical properties. The Zr content is not more than 0.15 wt %. Advantageously, Zr content is at least equal to 0.07 wt % and preferably at least equal to 0.08 wt %. In an advantageous embodiment, the products intended for the use according to the invention contain 0.09 to 0.15 wt % of zirconium and 0.50 to 0.60 wt % of manganese.

The titanium content is between 0.01 and 0.05 wt %. Adding titanium particularly helps refine grains during casting. However, an addition greater than 0.05 wt % can result in excessive fineness of the grain size which impedes the creep resistance at high temperature.

The iron and silicon contents are not more than 0.20 wt % each. In an advantageous embodiment of the invention, the iron content is not more than 0.18 wt % and preferably 0.15 wt %. In an advantageous embodiment of the invention, the silicon content is not more than 0.15 wt % and preferably 0.10 wt %.

The zinc content is not more than 0.25 wt %. In an advantageous embodiment, the zinc content is between 0.05 and 0.25 wt % and can particularly contribute to the mechanical strength. However, the presence of zinc can pose recycling problems. In a further embodiment, the zinc content is less than 0.20, preferably, less than 0.15 wt %.

The content of the other elements is less than 0.05 wt % and preferably less than 0.04 wt %. Preferably, the total of the other elements is less than 0.15 wt %. The other elements are typically unavoidable impurities. The remainder is aluminum.

The wrought products intended for the use according to the invention are preferably plates, profiles or forged products. The profiles are typically obtained by extrusion. The forged products can be obtained by forging cast blocks or extruded products or rolled products.

The process for manufacturing the products intended for the use according to the invention comprises the successive steps of preparing the alloy, casting, optionally homogenizing, hot working, solution heat treatment, quenching, cold working and ageing.

In a first step, a liquid metal bath is prepared so as to obtain an aluminum alloy with the composition according to the invention. The liquid metal bath is then typically cast in rolling ingot, extrusion billet or forging stock form.

Advantageously, the product thus cast is then homogenized so as to attain a temperature between 450° C. and 520° C. and preferably between 495° C. and 510° C. for a period between 5 and 60 hours. The homogenizing treatment can be performed in one or more phases.

The product is then hot-worked typically by rolling, extrusion and/or forging. The hot working is performed so as to maintain preferably a temperature of at least 300° C. Advantageously, a temperature of at least 350° C. and preferably at least 380° C. is maintained during the hot working. Significant cold working, particularly by cold rolling, is not performed between the hot working and the solution heat treatment. Significant cold working is typically a deformation of at least around 5%.

The product thus worked then undergoes a solution heat treatment with a heat treatment enabling to reach a temperature between 485 and 520° C. and preferably between 495 and 510° C. for 15 min to 8 h, then quenched.

The quality of the solution heat treatment can be evaluated by calorimetry and/or optical microscopy.

The wrought product obtained, typically a plate, a profile or a forged product, then undergoes cold working. Advantageously, the cold working is a 2 to 5% deformation enabling to increase the mechanical strength and obtain a T8 temper after ageing. The cold working can particularly be a controlled stretching resulting in a T851 temper or compressive working resulting in a T852 temper.

Finally, ageing is performed wherein the product attains a temperature between 160 and 210° C. and preferably between 175 and 195° C. for 5 to 100 hours and preferably from 10 to 50 h. In an advantageous embodiment, ageing is performed wherein the product attains a temperature between 170 and 180° C. for 10 to 15 hours. The ageing can be performed in one or more phases. Preferably, the ageing conditions are determined so that the mechanical strength R_{p0.2} is maximum (“peak” ageing). The ageing under the conditions according to the invention particularly makes it possible to improve the mechanical properties and the stability thereof during long term exposure at 150° C.

The thickness of the products intended for the use according to the invention is advantageously between 6 mm and 300 mm, preferably between 10 and 200 mm. A plate is a rolled product with a rectangular cross-section of uniform thickness. The thickness of the profiles is defined as per the standard EN 2066:2001: the cross-section is divided into elementary rectangles of dimensions A and B; A always being the greatest dimension of the elementary rectangle and B optionally being consisted as the thickness of the elementary rectangle.

The wrought products obtained according to the process of the invention have the advantage of having a high mechanical strength and good performances at high temperature. Thus, the wrought products intended for the use according to the invention preferably have in the longitudinal direction an ultimate tensile strength Rₘ of at least 490 MPa and preferably at least 495 MPa and have after long term exposure at 150° C. for 1000 h, an ultimate tensile strength Rₘ of at least 475 MPa and preferably at least 480 MPa. The wrought products intended for the use according to the invention are creep-resistant. Thus, the wrought products intended for the use according to the invention preferably have a necessary period to attain a 0.35% deformation during a creep test as per the standard ASTM E139-06 for a stress of 250 MPa and at a temperature of 150° C. of at least 700 hours and preferably of at least 800 h.

The products intended for the use according to the invention are particularly useful for applications wherein the products are kept at temperatures of 80° C. to 250° C. and preferably from 100° C. to 200° C., typically at around 150° C., for a significant period of at least 200 hours and preferably of at least 2000 hours.

Thus, the products intended for the use according to the invention are useful for applications such as a structural component or attachment means near engines in the automotive or aerospace industry or preferably for applications as rotors or other components particularly air suction pump boosters such as particularly vacuum pumps, such as in particular turbomolecular pumps or for applications as air blowing device components such as boosters.

These aspects, as well as others of the invention, are explained in more detail using the following illustrative and non-limiting examples.

### EXAMPLES

### Example 1

In this example, 6 alloys were cast in rolling ingot form. Alloys A and B have a composition according to the invention. Alloys C and E are disclosed by the application WO2012/140337 for their performances in uses at high temperature. Alloy F is an AA2618 alloy, known for its performances in uses at high temperature.

The composition of the alloys in wt % is given in Table 1.

TABLE 1

| Alloy | Si | Fe | Cu | Mn | Mg | Ni | Zn | Ti | Zr |
|---|---|---|---|---|---|---|---|---|---|
| A (Invention) | 0.08 | 0.14 | 4.2 | 0.51 | 1.35 | — | 0.20 | 0.02 | 0.02 |
| B (Invention) | 0.04 | 0.07 | 4.0 | 0.58 | 1.40 | — | 0.12 | 0.02 | 0.10 |
| C (Reference) | 0.04 | 0.05 | 3.3 | 0.34 | 1.9 | — | — | 0.02 | 0.11 |
| D (Reference) | 0.04 | 0.05 | 4.2 | 0.34 | 1.3 | — | — | 0.02 | 0.11 |
| E (Reference) | 0.04 | 0.05 | 3.7 | 0.34 | 1.6 | — | — | 0.02 | 0.11 |
| F (Reference) | 0.22 | 1.10 | 2.6 | 0.05 | 1.60 | 1.10 | 0.08 | 0.01 | 0.00 |

The ingots were homogenized at a temperature between 490° C. and 540° C., adapted according to the alloy, hot rolled to a thickness of 10 mm (alloy A) and 15 mm (alloys B to E) and 21 mm (alloy F), solution heat treated at a temperature between 490° C. and 540° C., adapted according to the alloy, water-quenched by immersion, stretched by 2 to 4% and aged at 175° C. or 190° C. to attain the peak tensile yield strength in the T8 temper. Thus, the ingots made of alloy A and B were homogenized between 20 and 36 h at 495° C., the plates obtained after rolling were solution heat treated for 2 h at 498° C. and aged for 8 h at 190° C. or 12 h at 175° C. The ingot made of alloy C was homogenized in two phases of 10 h at 500° C. followed by 20 h at 509° C., the plate obtained after rolling was solution heat treated for 2 h at 507° C. and aged for 12 h at 190° C. The ingot made of alloy D was homogenized in two phases of 10 h at 500° C. followed by 20 h at 503° C., the plate obtained after rolling was solution heat treated for 2 h at 500° C. and aged for 8 h at 190° C. The ingot made of alloy E was homogenized in two phases of 10 h at 500° C. followed by 20 h at 503° C., the plate obtained after rolling was solution heat treated for 2 h at 504° C. and aged for 12 h at 190° C.

The mechanical properties obtained at mid-thickness at 25° C. in the longitudinal direction before and after long term exposure are given in Table 2 in MPa.

TABLE 2

| | | Property | Long term exposure time (h) | | | | | |
|---|---|---|---|---|---|---|---|---|
| Alloy | Ageing | (MPa) | 0 | 1000 | 2000 | 3000 | 5000 | 10000 |
| A | 8 h | R_{0.2} | 483 | 431 | | 362 | | 334 |
| | 190° C. | Rm | 511 | 480 | | 440 | | 417 |
| B | 8 h | R_{0.2} | 459 | 421 | | 394 | | 351 |
| | 190° C. | Rm | 500 | 483 | | 460 | | 432 |
| A | 12 h | R_{0.2} | | 448 | | 413 | | 378 |
| | 175° C. | Rm | | 490 | | 474 | | 452 |
| B | 12 h | R_{0.2} | | 416 | | 394 | | 353 |
| | 175° C. | Rm | | 474 | | 465 | | 435 |
| C | 12 h | R_{0.2} | 456 | 447 | 436 | | 421 | |
| | 190° C. | Rm | 476 | 467 | 467 | | 455 | |
| D | 8 h | R_{0.2} | 470 | 427 | 411 | | 386 | |
| | 190° C. | Rm | 483 | 472 | 463 | | 449 | |
| E | 12 h | R_{0.2} | 468 | 462 | 440 | | 424 | |
| | 190° C. | Rm | 485 | 484 | 473 | | 466 | |
| F | | R_{0.2} | 420 | 406 | | 387 | | 355 |
| | | Rm | 445 | 435 | | 420 | | 406 |

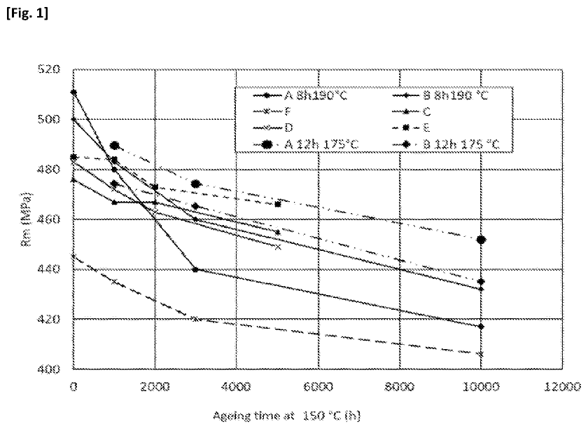

The evolution of the ultimate tensile strength with the duration of long term exposure at 150° C. is represented in FIG. 1. The products intended for the use according to the invention have an ultimate tensile strength Rₘ greater than that of the reference products before long term exposure and greater than most of the other alloys after 1000 hours at 150° C. After 3000 hours of long term exposure, the products intended for the use according to the invention have a greater mechanical strength Rₘ than that of alloy F, which is an AA2618 alloy known for its properties at high temperature.

Creep tests were performed as per the standard ASTM E139-06 for a stress of 285 MPa and at a temperature of 150° C. (alloys C, E and F) and for a stress of 250 MPa and at a temperature of 150° C. (alloys A, B and F). The period required to attain 0.35% deformation was particularly measured. The results are compiled in Table 3.

TABLE 3

| | | Period required to | Improvement factor |
|---|---|---|---|
| | Stress (MPa) L | attain 0.35% | with respect to alloy |
| Alloy | Direction | deformation (h) | F |
| A | 250 | 815 | 5.5 |
| B | 250 | 2100 | 14.1 |
| F | 250 | 149 | — |
| C | 285 | 221 | 3.6 |
| E | 285 | 267 | 4.4 |
| F | 285 | 61 | — |

The performance of the products intended to the use according to the invention in the creep test is largely greater than that of a reference product for uses at high temperature (product F) and also greater than that of products C and E.

### Example 2

In this example, the evolution of the yield strength R_{p0.2} with duration of long term exposure at 150° C. for a rolled product made of alloy B of thickness 10 mm obtained with the process as described in example 1 was compared with a rolled product made of alloy B of thickness 10 mm in the T351 temper. For the T351 temper product, a long term exposure of 233 h at 150° C. is estimated thanks to the data obtained after an 8 h treatment at 190° C.

The equivalent time tᵢ at 150° C. is defined by formula 1:

$${t}_{i} = \frac{\int exp ( ‐ 16400 / T ) dt}{exp ( ‐ 16400 / {T}_{ref} )} . \qquad [ Formula 1 ]$$

where T (in Kelvin) is the instantaneous treatment temperature of the metal, which evolves over the time t (in hours), and T_{ref} is a reference temperature set to 423 K. tᵢ is expressed in hours. The constant Q/R=16400 K is derived from the activation energy for the diffusion of Cu, for which the value Q=136100 J/mol was used. For the T851 temper product, the long term exposure was estimated for 233 h by linear approximation using the value of 426 MPa obtained after 1000 h.

The results are shown in Table 4.

TABLE 4

| | | R_{p0.2} (TL) [MPa] after | |
|---|---|---|---|
| | | long term exposure at | |
| | R_{p0.2} (TL) [MPa] | 150° C. | Δ R_{p0.2} [%] |
| T351 | 349 | 459 | 32% |
| T851 | 459 | 451 | −2% |

It is observed that the thermal stability of the T851 temper product is largely greater than the thermal stability of the T351 temper.

1. A product comprising a wrought aluminum alloy in a T8 temper with the following composition, in wt %,
Cu: 3.6-4.4
Mg: 1.2-1.4
Mn: 0.5-0.8
Zr: ≤0.15
Ti: 0.01-0.05
Si≤0.20
Fe≤0.20
Zn≤0.25
other elements<0.05
the remainder being aluminum,
in an application wherein said product is kept at a temperature of 80° C. to 250° C. for a significant period of at least 200 hours.

2. The product according to claim 1 wherein Cu is at least equal to 3.9 wt % and optionally at least equal to 4.0 wt % and/or Cu is at most 4.3 wt % and optionally at most 4.25 wt %.

3. The product according to claim 1 wherein the Mn content is between 0.51 and 0.65 wt %.

4. The product according to claim 1 wherein Zr is at least equal to 0.07 wt % and optionally at least equal to 0.08 wt %.

5. The product according to claim 1 wherein the thickness of said wrought product is between 6 mm and 300 mm and optionally between 10 and 200 mm.

6. The product according to claim 1 wherein said wrought product has in the longitudinal direction an ultimate tensile strength Rₘ of at least 490 MPa and optionally at least 495 MPa and has after long term exposure at 150° C. for 1000 h, an ultimate tensile strength Rₘ of at least 475 MPa and optionally at least 480 MPa.

7. The product according to claim 1 wherein said wrought product has a necessary period to attain a 0.35% deformation during a creep test as per the standard ASTM E139-06 for a stress of 250 MPa and at a temperature of 150° C. of at least 700 hours and optionally of at least 800 h.

8. The product according to claim 1 wherein the process for manufacturing said wrought product comprises, successively,
preparing a liquid metal bath so as to obtain said wrought aluminum alloy,
casting said alloy optionally in rolling ingot, extrusion billet or forging stock form,
optionally homogenizing the product thus cast so as to attain a temperature between 450° C. and 520° C.,
hot working the product thus obtained,
solution heat treating the product thus hot worked with a heat treatment enabling to reach a temperature between 485 and 520° C. and optionally between 495 and 510° C. for 15 min to 8 h, then quenching,
cold working the product thus solution heat treated and quenched,
ageing wherein the product thus obtained attains a temperature between 160 and 210° C. and optionally between 175 and 195° C. for 5 to 100 hours and p optionally from 8 to 50 h to obtain a T8 temper.

9. The product according to claim 1, wherein the product is kept at temperatures of 100° C. to 200° C.

10. The product according to claim 1 wherein the application is a structural component or attachment means near engines in automotive or aerospace industry.

11. The product according to claim 1 wherein the application is a rotor or another component of an air suction pump optionally a vacuum pump, optionally a turbomolecular pump.

12. The product according to claim 1 wherein the application is a component of an air blowing device optionally a booster.
